(19) United States
(12) Patent Application Publication
(10) Pub. No.: US 2009/0042091 A1
(43) Pub. Date: Feb. 12, 2009

(54) Supported catalyst layers for direct oxidation fuel cells

(75) Inventors: Xiaoming Huang, State College, PA (US); Xinhuai Ye, State College, PA (US); Chao-Yang Wang, State College, PA (US); Takashi Akiyama, Osaka (JP)

Correspondence Address: MCDERMOTT WILL & EMERY LLP, 600 13TH STREET, N.W., WASHINGTON, DC, 20005-3096, US

(73) Assignees: MATSUSHITA ELECTRIC INDUSTRIAL CO., LTD.; THE PENN STATE RESEARCH FOUNDATION

(21) Appl. No.: 11/889,102

(22) Filed: Aug. 9, 2007

(51) Int. Cl. H01M 4/92; B05D 5/00; C23F 1/00

(52) U.S. Cl. 429/41; 427/115; 216/95; 429/40

(57) ABSTRACT

A method of fabricating a supported catalyst layer for use in a fuel cell electrode, comprises sequential steps of: combining a fluid ink including a supported catalyst comprising at least one precious metal or alloy supported on particles of a support material, and a solution of at least one ionomeric polymer material, with at least one pore-forming material; forming a layer of the combined ink on a surface of a sheet of support material; hot pressing the layer; and treating the hot-pressed layer to remove pore-forming material to form a supported catalyst layer.

### FIELD OF THE DISCLOSURE

The present disclosure relates generally to fuel cells, fuel cell systems, and catalyst containing electrodes for use in membrane electrode assemblies of direct oxidation fuel cells. More specifically, the present disclosure relates to catalyst layers for use in electrodes utilized in membrane electrode assemblies comprising polymer electrolyte membranes for direct oxidation fuel cells, such as direct methanol fuel cells, and their method of fabrication.

### BACKGROUND OF THE DISCLOSURE

A direct oxidation fuel cell (hereinafter “DOFC”) is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol (“MeOH”), formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell (hereinafter “DMFC”). A DMFC generally employs a membrane-electrode assembly (hereinafter “MEA”) having an anode, a cathode, and a proton-conducting polymer electrolyte membrane (hereinafter “PEM”) positioned therebetween. A typical example of a PEM is one composed of an ionomeric perfluorosulfonic acid-tetrafluorethylene copolymer having a hydrophobic fluorocarbon backbone and perfluoroether side chains containing a strongly hydrophilic pendant sulfonic acid group (SO₃H), such as Nafion® (Nafion® is a registered trademark of E.I. Dupont de Nemours and Company). When exposed to H₂O, the hydrolyzed form of the sulfonic acid group (SO₃⁻H₃O⁺) allows for effective proton (H⁺) transport across the membrane, while providing thermal, chemical, and oxidative stability. In a DMFC, a methanol/water solution is directly supplied to the anode as the fuel and air is supplied to the cathode as the oxidant. At the anode, the methanol reacts with the water in the presence of a catalyst, typically a Pt—Ru alloy-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DMFC, the protons (i.e., H⁺ ions) migrate to the cathode through the proton-conducting membrane electrolyte, which is non-conductive to electrons (e⁻). The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+3/2O₂→CO₂+2H₂O (3)

The ability to use highly concentrated fuel is desirable for portable power sources, particularly since DMFC technology is currently competing with advanced batteries, such as those based upon lithium-ion technology.

In practice, however, liquid fuel electrochemical oxidation reactions, such as that shown for MeOH in equation (1) supra, do not proceed as readily as that for hydrogen (H₂). As a consequence, a principal factor in the lowering of electrical performance of DOFCs, e.g., DMFCs, occurs due to the presence of significant activation energy overvoltages (η_{act}) at the anode and cathode electrodes.

Typically, an alloy of platinum (Pt) and ruthenium (Ru) is utilized as a catalyst for the oxidation reaction at the anode electrode (as expressed in eq. (1)), and Pt is utilized as a catalyst for the reduction reaction at the cathode electrode (as expressed in eq. (2) supra). A currently utilized approach for reducing the activation energy overvoltages at the anode and cathode electrodes, as well as for mitigating carbon monoxide (CO) poisoning of the anode and mixed potential generation at the cathode, is to utilize high loading of the precious metal-based catalysts, e.g., loading at levels about tenfold greater than with hydrogen/air fuel cells. Disadvantageously, however, this represents a significant obstacle for cost-effective commercialization of DOFC/DMFC technology for use as portable power sources.

In view of the foregoing, there exists a need for improved catalyst layers for electrodes for MEAs and DOFC/DMFC systems, as well as methodologies for fabricating same.

### SUMMARY OF THE DISCLOSURE

Advantages of the present disclosure include a supported catalyst layer for use in a fuel cell electrode, their manufacturing methodology, and their use in an electrode of a direct oxidation fuel cell (DOFC), such as a direct methanol fuel cell (DMFC).

Still other advantages of the present disclosure are improved electrodes and MEAs for DOFCs and DMFCs.

Additional advantages and features of the present disclosure will be set forth in the disclosure which follows and in part will become apparent to those having ordinary skill in the art upon examination of the following or may be learned from the practice of the present disclosure. The advantages may be realized and obtained as particularly pointed out in the appended claims.

According to an aspect of the present disclosure, the foregoing and other advantages are achieved in part by a supported catalyst layer for use in a fuel cell electrode, and a method for fabricating such a catalyst layer, comprising sequential steps of:

(a) combining at least one pore-forming material with a fluid ink comprising a supported catalyst and at least one ionomeric polymer;

(b) forming a layer of the ink combined with the at least one pore-forming material on a surface of a sheet of support material;

(c) hot pressing the layer to form a hot-pressed layer on the surface of the sheet; and

(d) treating the hot-pressed layer to remove the at least one pore-forming material therefrom to form a supported catalyst layer.

Preferably, the supported catalyst comprises platinum (Pt) or a platinum-ruthenium (Pt—Ru) alloy supported on carbon (C)-based particles, and the at least one least one ionomeric polymer comprises a perfluorosulfonic acid-tetrafluorethylene copolymer having a hydrophobic fluorocarbon backbone and perfluoroether side chains containing a strongly hydrophilic pendant sulfonic acid group (SO₃H); and step (d) comprises washing the hot-pressed layer with a liquid solvent or solution for removing the at least one pore-forming material therefrom.

According to preferred embodiments of the present disclosure, step (a) comprises providing a fluid ink with a carbonate compound as the pore-forming material; and step (d) comprises washing the hot pressed layer with a solution of an acid such as sulfuric acid.

Preferred embodiments of the present disclosure include those wherein the supported catalyst comprises Pt—Ru/C and the weight ratio of Pt—Ru/C to the at least one ionomeric polymer is about 2.75.

Preferably, the supported catalyst comprises Pt—Ru/C; and step (b) comprises forming the layer with a Pt—Ru/C loading from about 3 to about 4 mg/cm².

Further preferred embodiments of the present invention include those wherein step (a) comprises minimizing dissolution of the at least one pore-forming material; and/or the at least one ionomeric polymer material contains sodium ions, and step (d) comprises exchanging the sodium ions with hydrogen ions.

In accordance with embodiments of the present disclosure, the at least one pore-forming material is selected from the group consisting of: carbonates, sulfonates, oxalates, and polymeric oxides.

Further aspects of the present disclosure include improved electrodes for DOFCs, comprising a supported catalyst layer formed by the above method, and improved anode electrodes for DMFCs, comprising a Pt—Ru/C supported catalyst layer formed by the above method.

A still further aspect of the present disclosure is an improved membrane electrode assembly (MEA) for use in a DOFC or DMFC fuel cell, comprising a polymer electrolyte membrane (PEM) sandwiched between a pair of electrodes, at least one of the electrodes comprising a supported catalyst layer formed according to the above method.

Still another aspect of the present disclosure is an improved method of fabricating a supported catalyst layer for use in an electrode of a direct oxidation fuel cell (DOFC), comprising steps of:

(a) combining a fluid ink including a supported catalyst comprising a platinum-ruthenium (Pt—Ru) alloy supported on carbon (C)-based particles, and a solution of at least one ionomeric perfluorosulfonic acid-tetrafluorethylene copolymer having a hydrophobic fluorocarbon backbone and perfluoroether side chains containing a strongly hydrophilic pendant sulfonic acid group (SO₃H), the weight ratio of the Pt—Ru/C supported catalyst to the at least one ionomeric polymer material being about 2.75, with at least one pore-forming material;

(b) forming a layer of the ink combined with the at least one pore-forming material on a sheet of a porous, gas permeable, electrically conductive material or a sheet of a decal material, the layer having a Pt—Ru/C loading from about 3 to about 4 mg/cm²;

(c) hot pressing the layer of ink to form a hot-pressed layer; and

(d) treating the hot-pressed layer to remove the at least one pore-forming material therefrom to form a supported catalyst layer.

According to preferred embodiments of the present disclosure, the at least one pore-forming material comprises a carbonate compound; and step (d) comprises washing the hot pressed layer with a solution of an acid to dissolve particles of the carbonate compound and form pores in the hot-pressed layer.

Preferably, step (a) comprises minimizing dissolution of the at least one pore-forming material; and/or step (a) comprises providing a fluid ink in which the at least one ionomeric polymer material contains sodium ions, and step (d) comprises exchanging the sodium ions with hydrogen ions.

Further aspects of the present disclosure include improved electrodes for DOFCs, comprising a supported catalyst layer formed by the above method, and improved anode electrodes for DMFCs, comprising a Pt—Ru/C supported catalyst layer formed by the above method.

A still further aspect of the present disclosure is an improved membrane electrode assembly (MEA) for use in a DOFC or DMFC fuel cell, comprising a polymer electrolyte membrane (PEM) sandwiched between a pair of electrodes, at least one of the electrodes comprising a supported catalyst layer formed according to the above method.

Additional advantages of the present disclosure will become readily apparent to those skilled in this art from the following detailed description, wherein only the preferred embodiments of the present disclosure are shown and described, simply by way of illustration of the best mode contemplated for practicing the present disclosure. As will be realized, the disclosure is capable of other and different embodiments, and its several details are capable of modification in various obvious respects, all without departing from the spirit of the present invention. Accordingly, the drawings and description are to be regarded as illustrative in nature, and not as restrictive.

### BRIEF DESCRIPTION OF THE DRAWINGS

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features, wherein:

FIG. 1 is a simplified, schematic illustration of a DOFC system capable of operating with highly concentrated methanol fuel, i.e., a DMFC system;

FIG. 2 is a schematic, cross-sectional view of a representative configuration of a MEA suitable for use in a fuel cell/fuel cell system such as the DOFC/DMFC system of FIG. 1;

FIG. 3 is a graph illustrating the variation of discharge voltage vs. test time of MEAs in DMFC applications, for comparing the performance of unsupported Pt—Ru catalyst layers and C-supported Pt—Ru catalyst layers with and without a pore forming material;

FIGS. 4 (A)-4 (B) show SEM images of catalyst layers sprayed on Teflon® substrates, for comparing when the H₂SO₄ washing treatment is performed prior to hot pressing (FIG. 4(A)) and subsequent to hot pressing (FIG. 4(B)); and

FIG. 5 is a graph illustrating the variation of discharge voltage vs. time of MEAs in DMFC applications, for comparing the performance of unsupported Pt—Ru catalyst layers and C-supported Pt—Ru catalyst layers with pore forming material, wherein the H₂SO₄ washing treatment is performed prior to hot pressing (“Initial”) and subsequent to hot pressing (“Improved”).

### DETAILED DESCRIPTION OF THE DISCLOSURE

The present disclosure relates to fuel cells and fuel cell systems with high power conversion efficiency, such as DOFC's and DOFC systems operating with highly concentrated fuel, e.g., DMFC's and DMFC systems fueled with about 2 to about 25 M MeOH solutions, improved catalyst layers for use in electrodes/electrode assemblies therefor, and to methodology for fabricating same.

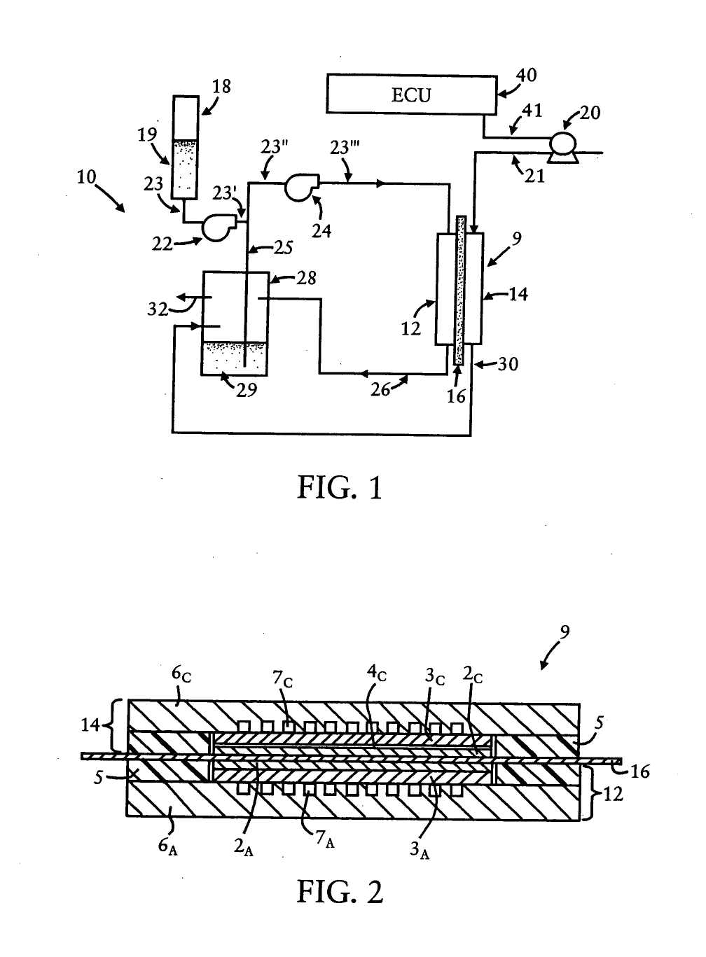

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions. (A DOFC/DMFC system is disclosed in a co-pending application filed Dec. 27, 2004, published Jun. 29, 2006 as U.S. Patent Publication US 2006-0141338 A1).

As shown in FIG. 1, DMFC system 10 includes an anode 12, a cathode 14, and a proton-conducting PEM 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAs and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”) separator 28 by pump 22 via associated conduit segments 23′ and 25, or directly to anode 12 via pumps 22 and 24 and associated conduit segments 23, 23′, 23″, and 23′″.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to L/G separator 28. Similarly, excess fuel (MeOH), H₂O, and CO₂ gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

During operation of system 10, air is introduced to the cathode 14 (as explained above) and excess air and liquid water are withdrawn therefrom via cathode exit port/conduit 30 and supplied to L/G separator 28. As discussed further below, the input air flow rate or air stoichiometry is controlled to maximize the amount of the liquid phase of the electrochemically produced water while minimizing the amount of the vapor phase of the electrochemically produced water. Control of the oxidant stoichiometry ratio can be obtained by setting the speed of fan 20 at a rate depending on the fuel cell system operating conditions or by an electronic control unit (hereinafter “ECU”) 40, e.g., a digital computer-based controller or equivalently performing structure. ECU 40 receives an input signal from a temperature sensor in contact with the liquid phase 29 of L/G separator 28 (not shown in the drawing for illustrative simplicity) and adjusts the oxidant stoichiometry ratio (via line 41 connected to oxidant supply fan 20) to maximize the liquid water phase in the cathode exhaust and minimize the water vapor phase in the exhaust, thereby reducing or obviating the need for a water condenser to condense water vapor produced and exhausted from the cathode of the MEA 2. In addition, ECU 40 can increase the oxidant stoichiometry beyond the minimum setting during cold-start in order to avoid excessive water accumulation in the fuel cell.

Liquid water 29 which accumulates in the L/G separator 28 during operation may be returned to anode 12 via circulating pump 24 and conduit segments 25, 23″, and 23′″. Exhaust carbon dioxide gas is released through port 32 of L/G separator 28.

The DOFC/DMFC system 10 shown in FIG. 1 comprises at least one MEA 9 which includes a PEM 16 and a pair of electrodes (an anode 12 and a cathode 14) each composed of a catalyst layer and a gas diffusion layer sandwiching the membrane. Typical PEM materials include fluorinated polymers having perfluorosulfonate groups (as described above) or hydrocarbon polymers, e.g., poly-(arylene ether ether ketone) (hereinafter “PEEK”). The PEM can be of any suitable thickness as, for example, between about 25 and about 200 μm. The catalyst layer typically comprises platinum (Pt) and/or ruthenium (Ru) based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a PEM 16 made of a material, such as described above, adapted for transporting hydrogen ions from the anode to the cathode during operation. The anode electrode 12 comprises, in order from PEM 16, a metal- or alloy-based catalyst layer 2_{A} in contact therewith, typically a layer of a Pt—Ru alloy, and an overlying gas diffusion layer (hereinafter “GDL”) 3_{A}; whereas the cathode electrode 14 comprises, in order from electrolyte membrane 16: (1) a metal-based catalyst layer 2_{C} in contact therewith, typically a Pt layer; (2) an intermediate, hydrophobic micro-porous layer (hereinafter “MPL”) 4_{C}; and (3) an overlying gas diffusion medium (hereinafter “GDM”) 3_{C}. GDL 3_{A} and GDM 3_{C} are each gas permeable and electrically conductive, and may be comprised of a porous carbon-based material including a carbon powder and a fluorinated resin, with a support made of a material such as, for example, carbon paper or woven or non-woven cloth, felt, etc. As indicated above, catalyst layers 2_{A} and 2_{C} are typically metal based and may, for example, comprise Pt and/or Ru. MPL 4_{C} may be formed of a composite material comprising an electrically conductive powder such as carbon black and a hydrophobic material such as PTFE.

Completing MEA 9 are respective electrically conductive anode and cathode separators 6_{A} and 6_{C} for mechanically securing the anode 12 and cathode 14 electrodes against PEM 16. As illustrated, each of the anode and cathode separators 6_{A} and 6_{C} includes respective channels 7_{A} and 7_{C} for supplying reactants to the anode and cathode electrodes and for removing excess reactants and liquid and gaseous products formed by the electrochemical reactions. Lastly, MEA 9 is provided with gaskets 5 around the edges of the cathode and anode electrodes for preventing leaking of fuel and oxidant to the exterior of the assembly. Gaskets 5 are typically made of an O-ring, a rubber sheet, or a composite sheet comprised of elastomeric and rigid polymer materials.

As indicated above, a drawback of conventional DOFCs/DMFCs is that liquid fuel electrochemical oxidation reactions, such as that shown for MeOH in equation (1) supra, do not proceed as readily as that for hydrogen (H₂). Consequently, a lowering of their electrical performance occurs due to the presence of significant activation energy overvoltages (η_{act}) at the anode and cathode electrodes. The currently utilized approach for reducing the activation energy overvoltages at the anode and cathode electrodes, as well as for mitigating carbon monoxide (CO) poisoning of the anode and mixed potential generation at the cathode, utilizes very high loading of the precious metal-based catalysts, such as Pt-based or Pt—Ru-based catalysts, at levels about tenfold greater than with hydrogen/air fuel cells. However, this approach requiring large amounts of expensive precious metals disadvantageously represents a significant obstacle for cost-effective commercialization of DOFC/DMFC technology for use as portable power sources.

An aim, therefore, of the present disclosure is to provide catalyst layers for use in electrodes utilized in MEAs of DOFCs/DMFCs and fabrication methodology therefor, with reduced precious metal loading and reduced activation energy overvoltages for performing anodic oxidation of fuels such as MeOH. For example, porous catalysts can be fabricated according to the present disclosure, such as precious metal-based supported catalysts layers, e.g., Pt—based or Pt—Ru alloy-based, carbon (C)-supported catalyst layers, which achieve high rates of MeOH oxidation with much lower precious metal catalyst loading.

In terms of electrocatalysis, finely dispersed, nano-particulate precious metal-based catalysts such as Pt and Pt—Ru mixtures or alloys provide much higher active surface area per gram of catalyst material when supported on a high surface area powder, typically an electrically conductive carbon (C) powder, than when unsupported. The highly dispersed character of carbon-supported Pt or Pt—Ru (hereinafter “Pt/C” and “Pt—Ru/C”) is beneficial for achieving high MeOH oxidation efficiency in DMFCs. However, conventional Pt or Pt—Ru/C electrocatalytic layers are much too thick for effectively using the entire active surface area thereof, due to the additional material arising from the carbon support and the high Pt or Pt—Ru loading when used in fuel cells. The lower utilization of catalyst surface due to limitation of mass transport through the excessively thick catalyst layer offsets the advantage of increased catalytic sites provided by the carbon support.

According to the present disclosure, a pore forming material is added to the supported catalyst layer to increase its porosity and therefore relax the limitation on mass transport imposed by a thick support. In this way, the advantages of high catalytic surface area provided by the support material and fuller utilization of the catalytic sites throughout the porous structure can be attained simultaneously.

A typical process for fabricating catalyzed electrodes for use in DOFC/DMFC applications involves a wet printing technique. According to one such technique, a liquid dispersion, slurry, or ink containing precious metal catalyst powder is applied to the surface of a sheet of a suitable support (substrate) material, typically a layer of porous, carbon-based material usable as a GDL by spraying or doctor blade application. According to another technique, the ink is applied to the surface of a sheet of a decal material, e.g., a Teflon® PTFE layer, to form a catalyst layer which is later separated therefrom. An ink suitable for fabricating improved catalyst layers according to the present disclosure can be prepared by mixing a supported catalyst such as Pt—Ru/C powder, e.g., 80% Pt—Ru alloy supported on a carbon material (Vulcan XC-72R, available from E-TEK, Inc.), Nafion® solution, isopropyl alcohol, and deionized water. A pore forming material, e.g., a carbonate compound, such as Li₂CO₃, is added to the catalyst ink during its preparation in order to form catalyst layers with desirable porous structure. As indicated above, the ink can be applied onto the surface of a substrate by any suitable conventional technique, in order to form the catalyst layer. The pore forming material is subsequently removed from the catalyst layer, as by washing with a suitable liquid, e.g., an acid solution, such as 1M sulfuric acid (H₂SO₄) when Li₂CO₃ is the pore forming material.

Other suitable carbonate compounds include ammonium carbonate, sodium carbonate, sodium bicarbonate, ammonium bicarbonate, and other suitable pore-forming materials, including for example, sulfonates, oxalates, and polymeric oxides. Other suitable liquid materials for removing the pore-forming material include, for example, mineral acids such as hydrochloric acid, phosphoric acid, and nitric acid.

According to the present disclosure, loading of the supported precious metal catalyst, e.g., Pt—Ru/C loading, is optimized in order to provide a balance between the catalyst kinetics and mass transport capability. For example, loading of a Pt—Ru/C catalyst which is too low may not afford sufficient catalytic activity; whereas, loading of a Pt—Ru/C catalyst which is too high may result in formation of an excessively thick catalyst layer which establishes a significant obstacle (i.e., impediment) to fuel (e.g., MeOH) transport therethrough. Optimal Pt—Ru/C loading has been determined to be in the range from about 3 to about 4 mg/cm² in DMFC applications.

The content of ionomeric polymer (e.g., Nafion®), i.e., the ratio of weight of dry supported catalyst (e.g., Pt—Ru/C) to weight of dry ionomeric polymer, can also be optimized. Specifically, high ionomeric polymer content in the catalyst layer extends the 3-phase contact of the reactant, electrolyte, and catalyst, and increases its activity in 3-dimensions because of the ability of protons (H⁺ ions) to move about the entire thickness of the layer. Therefore, the higher the ionomeric polymer content, the higher the proton conductivity. However, notwithstanding this relationship, formation of a thick ionomeric polymer layer on the surface of the catalyst material at high ionomeric polymer contents causes adverse effects which impose a limit on catalyst utilization. For example, an optimal weight ratio of Pt—Ru/C to Nafion® in DMFC applications has been determined to be about 2.75.

Although the use of supported precious metal-based catalysts (e.g., C-supported) enables a greater than about 50% reduction in the amount of precious metal catalyst (e.g., Pt and/or Ru) vis-à-vis unsupported catalysts (i.e., about 6 to about 8 mg/cm²), the supported catalyst layers are thicker than the unsupported catalyst layers due to the inclusion of the support particles (e.g., carbon particles). In addition, due to their different structures, formation of agglomerates occurs more readily with supported catalysts (e.g., Pt—Ru/C) than with unsupported catalysts (e.g., Pt—Ru), yielding layers with denser structure. The denser structure of the supported catalyst layers not only decreases the area available for electrochemical reaction, but also severely limits the transport of reactants (e.g., MeOH) therethrough. Therefore, addition of the pore forming material as described supra is advantageous in facilitating formation of a more open pore structure in the supported catalyst layers. It has been determined that optimal loading of the pore forming material in anode electrodes for DMFCs should be controlled at an about 2:1 ratio (by weight) in order to provide desirable pore volume.

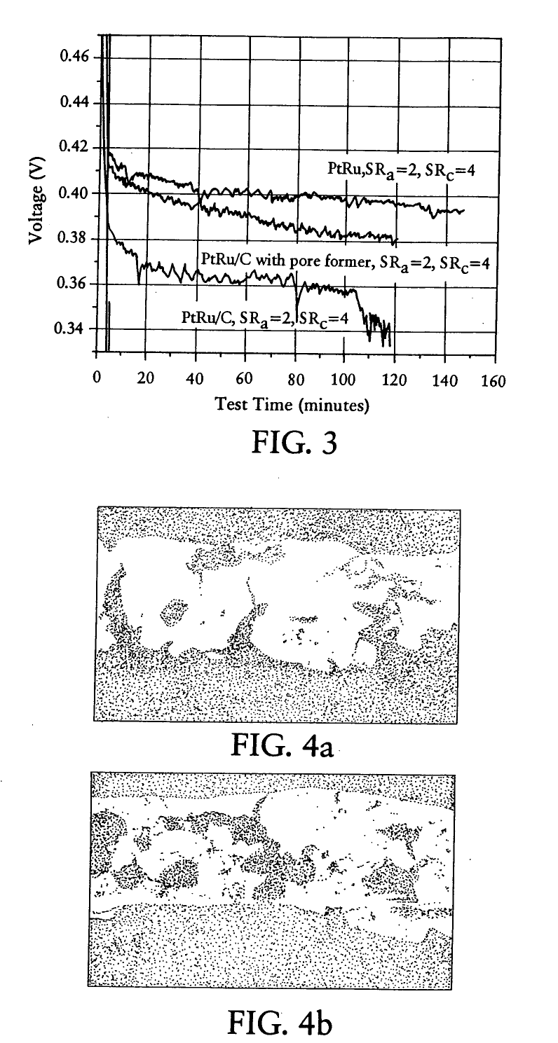

Referring to FIG. 3, shown therein is a graph illustrating the variation of discharge voltage vs. test time of MEAs in DMFC applications, for comparing the performance of unsupported Pt—Ru catalyst layers and supported Pt—Ru catalyst layers (Pt—Ru/C) formed with and without a pore forming material. The tested cells were temperature controlled at 60° C. during operation and supplied with 2M MeOH feed at the anode side with anode stoichiometry (“SRₐ”) of 2, corresponding to a MeOH flow rate of 0.19 ml/min., while air was supplied at the cathode side with cathode stoichiometry (“SR_{c}”) of 4, corresponding to a MeOH flow of 133 ml/min. As is evident from FIG. 3, the discharge voltage performance of the MEA having an optimized Pt—Ru/C catalyst layer including pore forming material is: (1) greatly improved for MeOH transport therethrough, relative to that of the MEA with Pt—Ru/C catalyst layer without pore forming material; and (2) approaches that of the MEA with the unsupported Pt—Ru catalyst layer having much higher catalyst loading.

MEAs for DMFCs according to the present disclosure (e.g., of structure such as described supra in reference to FIG. 2) may be formed by a process comprising hot pressing together a sandwich structure comprising an anode electrode with a catalytic layer thereon, a PEM, and a cathode electrode with a catalytic layer thereon, with each of the catalytic layers in contact with the PEM. The pore forming material may be removed from the catalytic layer(s) prior to the hot pressing process, as by washing with a suitable solvent (e.g., H₂SO₄ for removal of Li₂CO₃ pore forming particles). However, it has been determined by Scanning Electron Microscopy (SEM) studies that when the hot pressing process is performed subsequent to the washing for removal of the pore forming material, disadvantageous compressive collapse of at least some of the pores occurs, thereby resulting in loss of pore volume.

According to the present disclosure, a process/methodology has been developed which eliminates, or at least substantially mitigates, the deleterious compressive effect of the aforementioned hot pressing process. Specifically, according to the improved process methodology, hot pressing and decal transfer of the catalyst layers onto a fluorinated ionomer (e.g., Nafion®) is performed prior, rather than subsequent, to solvent washing of the catalytic layer(s) for removal of the pore forming material, followed by assembly of the MEA. In this regard, FIGS. 4 (A)-4 (B) show SEM images of catalyst layers sprayed on Teflon® substrates, for comparing porosity when the H₂SO₄ washing treatment is performed prior to hot pressing (FIG. 4 (A)) and subsequent to hot pressing (FIG. 4 (B)). As is evident therefrom, the improved process methodology provided according to the present disclosure affords a substantial improvement in pore maintenance upon hot pressing.

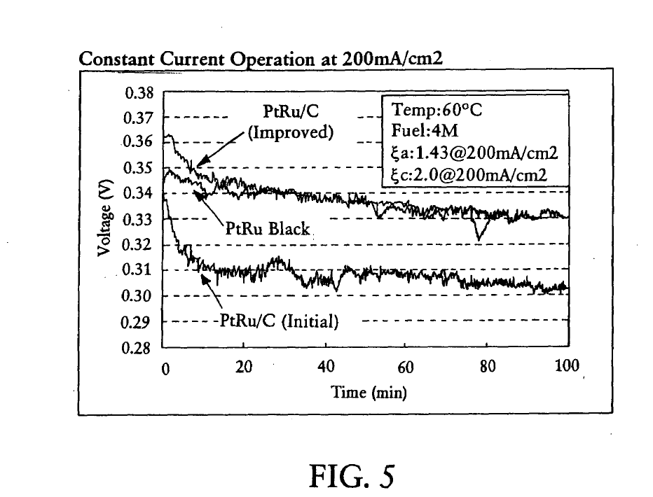

Adverting to FIG. 5, shown therein is a graph illustrating the variation of discharge voltage vs. operation time of MEAs in DMFC applications. The graph compares the performance of unsupported Pt—Ru catalyst layers (i.e. PtRu Black) and Pt—Ru/C catalyst layers with pore forming material, wherein the H₂SO₄ washing treatment of the Pt—Ru/C layers is performed prior to hot pressing (“Initial”) or subsequent to hot pressing (“Improved”). The comparison was made at constant current operation at 200 mA/cm² and at a temperature of about 60° C. with a fuel concentration of 4 M and an oxidant stoichiometry ξa of 1.43 at 200 mA/cm² and ξc of 2.0 at 200 mA/cm². As may be seen from the performance results shown in FIG. 5, the DMFC with MEA comprising an “Improved” anode electrode with Pt—Ru/C catalyst layer prepared by the improved process methodology afforded by the present disclosure: (1) exhibits significantly higher voltage than the DMFC with MEA comprising the “Initial” anode electrode; and (2) is virtually identical to that of the DMFC with MEA comprising an anode electrode with unsupported Pt—Ru catalyst layer, while containing about 30% less catalyst loading.

It has also been determined, via weight loss studies, that the pore forming material added to the ink, e.g., Li₂CO₃, can be dissolved by the solution of ionomeric polymer, e.g., Nafion®, during preparation of the catalyst ink, whereby the pore forming material is effectively lost as a pore former. In extreme instances, the loss of pore forming material can be as great as about 80% if the ink is stirred for about 4 hrs. Loss of pore forming material via dissolution can be effectively eliminated, or at least mitigated, by controlling (i.e., limiting) the duration of ink stirring after addition of the pore forming material and/or using an ionomeric polymer containing sodium ions. Such a material can be prepared by exchanging H⁺ ions of the ionomeric polymer (Nafion®) with Na⁺ ions by adding NaOH to the ink prior to addition of the pore forming material (Li₂CO₃). The Na⁺ ions are then later exchanged with H⁺ ions during the treatment of the catalyst layer with H₂SO₄ solution for removing the pore forming material therefrom.

In summary, therefore, the present disclosure provides ready fabrication of improved cathode and anode electrodes and MEAs for use in DOFCs such as DMFCs. The improved electrodes and MEAs afforded by the instant disclosure which include improved catalyst layers with reduced precious metal loading advantageously exhibit excellent performance properties, rendering them especially useful in high power density, high energy density DMFC applications. In addition, the methodology for fabricating the electrodes with improved porous, supported catalyst layers is simple and cost effective in mass production. In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

What is claimed is:

1. A method of fabricating a supported catalyst layer for use in a fuel cell electrode, comprising sequential steps of:
(a) combining at least one pore-forming material with a fluid ink comprising a supported catalyst and at least one ionomeric polymer;
(b) forming a layer of said ink combined with said at least one pore-forming material on a surface of a sheet of support material;
(c) hot pressing said layer to form a hot-pressed layer on said surface of said sheet; and
(d) treating said hot-pressed layer to remove said at least one pore-forming material therefrom to form a supported catalyst layer.

2. The method according to claim 1, wherein:
said supported catalyst comprises platinum (Pt) or a platinum-ruthenium (Pt—Ru) alloy supported on carbon (C)-based particles.

3. The method according to claim 1, wherein:
said at least one ionomeric polymer comprises a perfluorosulfonic acid-tetrafluorethylene copolymer having a hydrophobic fluorocarbon backbone and perfluoroether side chains containing a strongly hydrophilic pendant sulfonic acid group (SO₃H).

4. The method according to claim 1, wherein:
step (d) comprises washing said hot-pressed layer with a liquid solvent or solution for removing said at least one pore-forming material therefrom.

5. The method according to claim 4, wherein:
step (a) comprises combining the fluid ink with a carbonate compound as said pore-forming material; and
step (d) comprises washing said hot pressed layer with a solution of an acid to dissolve particles of said carbonate compound.

6. The method according to claim 5, wherein:
step (d) comprises washing said hot pressed layer with a solution of sulfuric acid.

7. The method according to claim 1, wherein:
said supported catalyst comprises Pt—Ru/C and the weight ratio of said Pt—Ru/C to said at least one ionomeric polymer material is about 2.75.

8. The method according to claim 1, wherein:
said supported catalyst comprises Pt—Ru/C; and
step (b) comprises forming said layer with a Pt—Ru/C loading from about 3 to about 4 mg/cm².

9. The method according to claim 1, wherein:
step (a) comprises minimizing dissolution of said at least one pore-forming material in said ink.

10. The method according to claim 1, wherein:
said at least one ionomeric polymer material contains sodium ions; and
step (e) comprises exchanging said sodium ions with hydrogen ions.

11. The method according to claim 1, wherein:
said at least one pore-forming material is selected from the group consisting of: carbonates, sulfonates, oxalates, and polymeric oxides.

12. An electrode for a DOFC comprising a supported catalyst layer formed by the process according to claim 1.

13. An anode electrode for a DMFC comprising a Pt—Ru/C supported catalyst layer formed by the process according to claim 1.

14. A membrane electrode assembly (MEA) for use in a DOFC or DMFC fuel cell, comprising a polymer electrolyte membrane (PEM) sandwiched between a pair of electrodes, at least one of said electrodes comprising a supported catalyst layer formed according to the method of claim 1.

15. A method of fabricating a supported catalyst layer for use in an electrode of a direct oxidation fuel cell (DOFC), comprising steps of:
(a) combining a fluid ink including a supported catalyst comprising a platinum-ruthenium (Pt—Ru) alloy supported on carbon (C)-based particles, and a solution of at least one ionomeric perfluorosulfonic acid-tetrafluorethylene copolymer having a hydrophobic fluorocarbon backbone and perfluoroether side chains containing a strongly hydrophilic pendant sulfonic acid group (SO₃H), the weight ratio of said Pt—Ru/C supported catalyst to said at least one ionomeric polymer material being about 2.75, with at least one pore-forming material;
(b) forming a layer of said ink combined with said at least one pore-forming material on a surface of a sheet of a porous, gas permeable, electrically conductive material or a sheet of a decal material, said layer having a Pt—Ru/C loading from about 3 to about 4 mg/cm²;
(c) hot pressing said layer of said ink to form a hot-pressed layer; and
(d) treating said hot-pressed layer to remove said at least one pore-forming material therefrom to form a supported catalyst layer.

16. The method according to claim 15, wherein:
said at least one pore-forming material comprises a carbonate compound; and
step (d) comprises washing said hot pressed layer with a solution of an acid to dissolve particles of said carbonate compound and form said pores in said hot-pressed layer.

17. The method according to claim 15, wherein:
step (a) comprises minimizing dissolution of said at least one pore-forming material.

18. The method according to claim 15, wherein:
said at least one ionomeric polymer material contains sodium ions; and
step (d) comprises exchanging said sodium ions with hydrogen ions.

19. An electrode for a DOFC comprising a upported catalyst layer formed by the process according to claim 15.

20. An anode electrode for a DMFC comprising a Pt—Ru/C supported catalyst layer formed by the process according to claim 15.

21. A membrane electrode assembly (MEA) for use in a DOFC or DMFC fuel cell, comprising a polymer electrolyte membrane (PEM) sandwiched between a pair of electrodes, at least one of said electrodes comprising a supported catalyst layer formed according to the method of claim 15.
